(19) United States
(12) Patent Application Publication
(10) Pub. No.: US 2006/0135721 A1
(43) Pub. Date: Jun. 22, 2006

(54) Method for producing polyisobutenes

(76) Inventor: Arno Lange, (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/559,779

(22) PCT Filed: Jun. 25, 2004
(86) PCT No.: PCT/EP04/06919

§ 371 Date: Dec. 7, 2005

(30) Foreign Application Priority Data
Jun. 26, 2003 (DE) 103 28 854.6

(51) Int. Cl. C08F 110/10

(52) U.S. Cl. 526/348.7

(57) ABSTRACT

The present invention relates to a process for preparing bifunctional polyisobutenes and to bifunctional polyisobutenes obtainable by means of the process and particular functionalization products thereof.

The present invention relates to a process for preparing bifunctional polyisobutenes and to bifunctional polyisobutenes obtainable by means of the process and particular functionalization products thereof.

Homopolymers and copolymers of isobutene are used in many ways, for example for producing fuel and lubricant additives, as elastomers, as adhesives or adhesive raw materials or as basic constituent of sealing compositions.

The preparation of isobutene polymers by living cationic polymerization of isobutene is known. The initiator system used generally comprises a Lewis acid and an organic compound which forms a carbocation or a cationogenic complex with the Lewis acid.

For further processing, for example to produce sealing compositions or adhesives (raw materials), telechelic isobutene polymers, i.e. polymers which have two or more reactive end groups, are particularly useful. These end groups are, in particular, carbon-carbon double bonds which can be functionalized further or groups which have been functionalized by means of a terminating agent. Thus, EP-A 722 957 describes the preparation of telechelic isobutene polymers using an at least bifunctional initiator such as dicumyl chloride. A disadvantage of the known processes is that the aromatic initiators described can react to form indanyl or diindane groups (cf. Cr. Pratrap, S. A. Mustafa, J. P. Heller, J. Polym. Sci. Part A, Polym. Chem. 1993, 31, pp. 2387-2391), which has an adverse effect on the targeted synthesis of defined telechelic isobutene polymers.

DE-A 10061727 describes the preparation of isobutene polymers having olefinically unsaturated end groups. To prepare isobutene polymers having two olefinically unsaturated end groups, bifunctional initiators are used. The reactivity of the end groups obtained here leaves something to be desired. The earlier German patent application DE 10232157.6 describes a cationic isobutene polymerization using 3-chlorocyclopentene as initiator.

It is an object of the present invention to provide a process by means of which bifunctional polyisobutenes can be obtained using a simple initiator system.

We have found that this object is achieved by a process for preparing bifunctional polyisobutenes, which comprises polymerizing isobutene or an isobutene-containing monomer mixture in the presence of a Lewis acid and a compound of the formula I

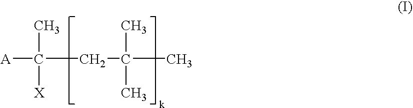

where

X is halogen, C₁-C₆-alkoxy or C₁-C₆-acyloxy,

A is an ethylenically unsaturated hydrocarbon radical containing a vinyl group or a cycloalkenyl group, and

k is from 0 to 5.

The invention accordingly provides a process for preparing bifunctional polymers, in which isobutene or an isobutene-containing monomer mixture is reacted with a compound of the formula I defined here in the presence of a Lewis acid. The compounds I will hereinafter also be referred to as initiators or initiator compounds I.

The process of the present invention makes it possible to obtain, in particular, isobutene polymers which have an olefinically unsaturated group A at one end (referred to as the start of the chain) and a halogen atom at the other end (referred to as distal end of the chain). Depending on the work-up conditions, it is also possible to obtain isobutene polymers which have an olefinic double bond in place of the halogen atom. The double bond can then be converted in a known manner into another function, e.g. OH, SH, silane, siloxane, hydroxyphenyl, succinyl ester, succinimide, oxirane, carboxyl, etc.

k is preferably 0 or 1, especially 0.

Halogen is preferably chlorine, bromine or iodine, in particular chlorine.

The alkoxy groups preferably have from 1 to 4 carbon atoms. Examples are methoxy, ethoxy, propoxy and butoxy.

The acyloxy groups preferably have from 1 to 4 carbon atoms and include, for example, acetyloxy, propionyloxy and butyroxy.

In the formula I, X is preferably halogen, in particular chlorine.

A is a hydrocarbon radical which generally has from 2 to 21 carbon atoms and is either a vinyl group (CH₂═CH—) or a C₅-C₈-cycloalkenyl radical, e.g. cyclopenten-3-yl, cyclopenten-4-yl, cyclohexen-3-yl, cyclohexen-4-yl, cyclohepten-3-yl, cyclohepten4-yl, cycloocten-3-yl, cycloocten-4-yl or cycloocten-5-yl.

A is preferably a radical of the formula A.1, A.2 or A.3

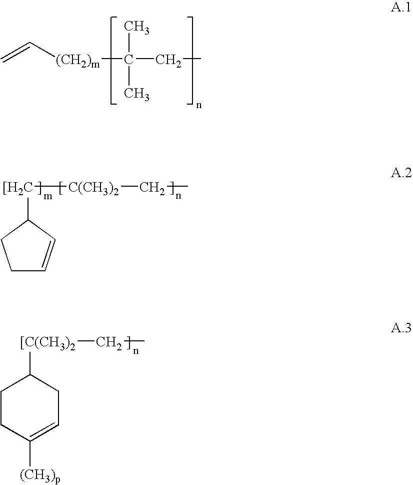

where

m is 0 or 1;

n is from 0 to 3, in particular 0, 1 or 2, and

p is0 or 1.

In compounds I in which A=A.2, m is preferably 1.

In compounds I in which A=A.3, n is preferably 0 and p is preferably 1.

Examples of initiator compounds I are:

2-chloro-2-methyl-3-butene, 2-chloro-2-methyl-4-pentene, 2-chloro-2,4,4-trimethyl-5-hexene, 2-chloro-2-methyl-3-(cyclopenten-3-yl)propane, 2-chloro-2-methyl-4-(cyclohexen-4-yl)pentane and 2-chloro-2-(1-methylcyclohexen-4-yl)propane.

Compounds of the formula I in which A is a radical A.1 are known or are obtainable by methods which are known per se from the prior art. Thus, a compound I in which A is A.1 and m is 0 and n is 0 can be obtained by Markovnikov addition of a hydrogen halide or a hydrohalic acid, a C₁-C₆-alcohol or a C₁-C₆-carboxylic acid onto isoprene. Such addition reactions are described, for example, in Organikum, 17th edition, VEB Verlag der Wissenschaften, Berlin 1988, chapter D4.

Suitable hydrogen halides (hydrohalic acids) are, for example, hydrogen chloride and hydrogen bromide or hydrochloric acid and hydrobromic acid.

Suitable C₁-C₆-alcohols are, for example, methanol, ethanol, propanol, isopropanol, butanol, isobutanol, tert-butanol, pentanol and hexanol.

Suitable C₁-C₆-carboxylic acids are, for example, acetic acid, propionic acid and butyric acid.

Compounds of the formula I in which A=A.1 and m is 0 and n≠0 can be prepared by reacting a compound I in which A=A.1, m=0 and n=0 in a controlled manner with from 1 to 3 molar equivalents of isobutene or with an oligoisobutene, e.g. 2,4,4-trimethyl-1-pentene, in the presence of a Lewis acid. When the reaction is stopped by means of a protic compound, for example water, an alcohol or a mixture thereof, the desired compound I is obtained. If a metal or semimetal halide having an electron pair gap is used as Lewis acid, compounds I in which X is a halogen atom are obtained. If desired, the group X, in particular when X=halogen, can be converted into a different group X. Methods of achieving this are known from the prior art, e.g. from Mayr, Klein and Kolberg, Chem. Ber. 117 (8), 1984, 2555, and from Lehmkuhl and Bergstein, Liebigs Ann. Chem. 1978, 1876-1879.

Compounds I in which A is A.1 and m is 1 can be obtained, for example, by addition of a hydrogen halide, e.g. HCl, onto 2-methyl-1,4-pentadiene and, if desired, subsequent controlled reaction of the resulting 2-halo-4-pentene with from 1 to 3 molar equivalents of isobutene or with an oligoisobutene, e.g. 2,4,4-trimethyl-1-pentene, in the presence of a Lewis acid. 2-Methyl-1,4-pentadiene itself is commercially available.

Compounds I in which A is a radical A.2 and m is 1 can be obtained, for example, by controlled reaction of a 3-halocyclopentene with isobutene in the presence of a Lewis acid and termination as described above of the resulting living isobutene oligomer.

Compounds I in which A is a radical A.3 and n≠0 can be obtained, for example, by controlled reaction of limonene hydrohalide with isobutene or an isobutene oligomer in the presence of a Lewis acid and termination as described above of the resulting living isobutene oligomer. The limonene hydrohalide is obtainable by hydrohalogenation, e.g. hydrochlorination, of limonene in a manner known per se.

Possible Lewis acids are covalent metal halides and semimetal halides which have an electron pair gap. Such compounds are known to those skilled in the art, for example from J. P. Kennedy et al. in U.S. Pat. No.4,946,889, U.S. Pat. No.4,327,201, U.S. Pat. No.5,169,914, EP-A-206 756, EP-A-265 053 and also in summarized form in J. P. Kennedy, B. Ivan, “Designed Polymers by Carbocationic Macromolecular Engineering”, Oxford University Press, New York, 1991. They are generally selected from among halogen compounds of titanium, tin, aluminum, vanadium and iron and the halides of boron. Preference is given to the chlorides, and in the case of aluminum also monoalkylaluminum dichlorides and dialkylaluminum chlorides. Preferred Lewis acids are titanium tetrachloride, boron trichloride, boron trifluoride, tin tetrachloride, aluminum trichloride, vanadium pentachloride, iron trichloride, alkylaluminum dichlorides and dialkylaluminum chlorides. Particularly preferred Lewis acids are titanium tetrachloride, boron trichloride and boron trifluoride, in particular titanium tetrachloride.

It has been found to be useful to carry out the polymerization in the presence of an electron donor. Suitable electron donors are aprotic organic compounds which have a free electron pair located on a nitrogen, oxygen or sulfur atom. Preferred donor compounds are selected from among pyridines such as pyridine itself, 2,6-dimethylpyridine and sterically hindered pyridines such as 2,6-diisopropylpyridine and 2,6-di-tert-butylpyridine; amides, in particular N,N-dialkylamides of aliphatic and aromatic carboxylic acids, e.g. N,N-dimethylacetamide; lactams, in particular N-alkyllactams such as N-methylpyrrolidone; ethers, e.g. dialkyl ethers such as diethyl ether and diisopropyl ether, cyclic ethers such as tetrahydrofuran; amines, in particular trialkylamines such as triethylamine; esters, in particular C₁-C₄-alkyl esters of aliphatic C₁-C₆-carboxylic acids, e.g. ethyl acetate; thioethers, in particular dialkyl thioethers and alkyl aryl thioethers, e.g. methyl phenyl sulfide; sulfoxides, in particular dialkyl sulfoxides such as dimethyl sulfoxide; nitriles, in particular alkyl nitriles such as acetonitrile and propionitrile; phosphines, in particular trialkylphosphines and triarylphosphines, e.g. trimethylphosphine, triethylphosphine, tri-n-butylphosphine and triphenylphosphine and aprotic organosilicon compounds which are not capable of polymerization and bear at least one organic radical bound via oxygen.

Among the abovementioned donors, preference is given to pyridine and sterically hindered pyridine derivatives and also, in particular, organosilicon compounds.

Preferred organosilicon compounds of this type are those of the formula III:
R^{a}ₙSi(OR^{b})₄₋ᵣ (III)

where r is 1, 2 or 3,
R^{a} may be identical or different and are each, independently of one another, C₁-C₂₀-alkyl, C₃-C₇-cycloalkyl, aryl or aryl-C₁-C₄-alkyl, where the latter three radicals may also bear one or more C₁-C₁₀-alkyl groups as substituents, and
R^{b} are identical or different and are each C₁-C₂₀-alkyl or, when r is 1 or 2, two radicals R^{b} may together form an alkylene group.

In the formula III, r is preferably 1 or 2. R^{a} is preferably a C₁-C₈-alkyl group, in particular a branched alkyl group or an alkyl group which is bound via a secondary carbon atom, e.g. isopropyl, isobutyl, sec-butyl, or a 5-, 6- or 7-membered cycloalkyl group or an aryl group, in particular phenyl. The variable R^{b} is preferably a C₁-C₄-alkyl group or a phenyl, tolyl or benzyl radical.

Examples of such preferred compounds are dimethoxydiisopropylsilane, dimethoxyisobutylisopropylsilane, dimethoxydiisobutylsilane, dimethoxydicyclopentylsilane, dimethoxyisobutyl-2-butylsilane, diethoxyisobutylisopropylsilane, triethoxytoluylsilane, triethoxybenzylsilane and triethoxyphenylsilane.

For the purposes of the present invention, C₁-C₄-alkyl is a branched or linear alkyl radical such as methyl, ethyl, propyl, isopropyl, n-butyl, sec-butyl, isobutyl or tert-butyl. C₁-C₈-Alkyl can also be pentyl, hexyl, heptyl, octyl and their structural isomers. C₁-C₂₀-Alkyl can also be nonyl, decyl, undecyl, dodecyl, tridecyl, tetradecyl, pentadecyl, hexadecyl, heptadecyl, octadecyl, nonadecyl, eicosyl and their structural isomers.

C₃-C₇-Cycloalkyl is, for example, cyclopropyl, cyclopentyl, cyclohexyl, cycloheptyl or cyclooctyl.

Aryl is, in particular, phenyl, naphthyl or tolyl.

Aryl-C₁-C₄-alkyl is, in particular, benzyl or 2-phenylethyl.

Alkylene is, for example, C₂-C₅-alkylene such as 1,2-ethylene, 1,2- or 1,3-propylene, 1,4-butylene or 1,5-pentylene.

The Lewis acid is used in an amount which is sufficient to form the initiator complex. The molar ratio of Lewis acid to initiator compound I is generally from 10:1 to 1:10, in particular from 1:1 to 1:4 and especially from 1:1 to 1:2.5.

The Lewis acid and the electron donor are preferably used in a molar ratio of from 20:1 to 1:20, particularly preferably from 5:1 to 1:5 and in particular from 2:1 to 1:2.

The concentration of Lewis acid in the reaction mixture is usually in the range from 0.1 to 200 g/l and in particular in the range from 1 to 50 g/l.

Isobutene feedstocks which are suitable for use in the process of the present invention include both isobutene itself and isobutene C₄-hydrocarbon streams, for example C₄ raffinates, C₄ fractions from isobutene dehydrogenation, C₄ fractions from steam crackers and FCC plants (FCC: fluid catalytic cracking), as long as they have been largely freed of 1,3-butadiene. C₄-hydrocarbon streams which are suitable for the purposes of the present invention generally contain less than 500 ppm, preferably less than 200 ppm, of butadiene. When C₄ fractions are used as starting material, the hydrocarbons other than isobutene assume the role of an inert solvent.

The reaction can also be carried out using monomer mixtures of isobutene with olefinically unsaturated monomers which are copolymerizable with isobutene under cationic polymerization conditions. Furthermore, the process of the present invention is suitable for the block copolymerization of isobutene with ethylenically unsaturated comonomers which are polymerizable under cationic polymerization conditions. If monomer mixtures of isobutene with suitable comonomers are to be copolymerized, the monomer mixture preferably comprises more than 80% by weight, in particular more than 90% by weight and particularly preferably more than 95% by weight, of isobutene and less than 20% by weight, preferably less than 10% by weight and in particular less than 5% by weight, of comonomers.

Possible copolymerizable monomers are vinylaromatics such as styrene and α-methylstyrene, C₁-C₄-alkylstyrenes such as 2-, 3- and 4-methylstyrene, and also 4-tert-butylstyrene, isoolefins having from 5 to 10 carbon atoms, e.g. 2-methyl-1-butene, 2-methyl-1-pentene, 2-methyl-1-hexene, 2-ethyl-1-pentene, 2-ethyl-1-hexene and 2-propyl-1-heptene. Further suitable comonomers are olefins which contain a silyl group, e.g. 1-trimethoxysilylethene, 1-(trimethoxysilyl)propene, 1-(trimethoxysilyl)-2-methyl-2-propene, 1-[tri(methoxyethoxy)silyl]ethene, 1-[tri(methoxyethoxy)silyl]propene, and 1-[tri(methoxyethoxy)silyl]-2-methyl-2-propene.

To prepare block copolymers, the distal end of the chain, i.e. the end of the isobutene polymer obtained which is farthest from the start of the chain which is derived from the initiator, can be reacted with comonomers such as those described above, e.g. vinylaromatics. Thus, it is possible, for example, firstly to homopolymerize isobutene and subsequently add the comonomer. The newly formed reactive chain end derived from the comonomer is either deactivated or terminated according to one of the embodiments described below to form a functional end group or reacted once again with isobutene to form higher block copolymers.

The polymerization is usually carried out in a solvent. Possible solvents are all low molecular weight, organic compounds or mixtures thereof which have a suitable dielectric constant and no protons which can be abstracted and which are liquid under the polymerization conditions. Preferred solvents are hydrocarbons, e.g. acyclic hydrocarbons having from 2 to 8, preferably from 3 to 8, carbon atoms, e.g. ethane, isopropane and n-propane, n-butane and its isomers, n-pentane and its isomers, n-hexane and its isomers and also n-heptane and its isomers, and n-octane and its isomers, cyclic alkanes having from 5 to 8 carbon atoms, e.g. cyclopentane, methylcyclopentane, cyclohexane, methylcyclohexane, cycloheptane, acyclic alkenes preferably having from 2 to 8 carbon atoms, e.g. ethene, isopropene and n-propene, n-butene, n-pentene, n-hexene and n-heptene, cyclic olefins such as cyclopentene, cyclohexene and cycloheptene, aromatic hydrocarbons such as toluene, xylene, ethylbenzene, and also halogenated hydrocarbons such as halogenated aliphatic hydrocarbons, e.g. chloromethane, dichloromethane, trichloromethane, chloroethane, 1,2-dichloroethane and 1,1,1-trichloroethane and 1-chlorobutane, and halogenated aromatic hydrocarbons such as chlorobenzene and fluorobenzene. The halogenated hydrocarbons used as solvents do not include any compounds in which halogen atoms are located on secondary or tertiary carbon atoms.

Particularly preferred solvents are aromatic hydrocarbons, among which toluene is particularly preferred. Preference is likewise given to solvent mixtures which comprise at least one halogenated hydrocarbon and at least one aliphatic or aromatic hydrocarbon. In particular, the solvent mixture comprises hexane and chloromethane and/or dichloromethane. The volume ratio of hydrocarbon to halogenated hydrocarbon is preferably in the range from 1:10 to 10:1, particularly preferably in the range from 4:1 to 1:4 and in particular in the range from 2:1 to 1:2.

The process of the present invention is generally carried out at below 0° C., e.g. in the range from 0 to −140° C., preferably in the range from −30 to −120° C. and particularly preferably in the range from 40 to −110° C. The reaction pressure is of subordinate importance.

The heat of reaction is removed in a customary manner, for example by wall cooling and/or by exploiting evaporative cooling.

To stop the reaction, the living distal ends of the chains are deactivated, for example by addition of a protic compound, in particular by addition of water, alcohols such as methanol, ethanol, n-propanol, isopropanol, n-butanol, isobutanol, sec-butanol or tert-butanol, or their mixtures with water.

The process of the present invention gives telechelic (bifunctional) polyisobutenes which have, firstly, an ethylenically unsaturated group at the start of the chain which is introduced by the radical A of the initiator compound of the formula I and, secondly, an end (distal end of the chain, i.e. chain end opposite the start of the chain) having a functional group. This functional group is preferably a —CH₂—C(CH₃)₂-halogen group. This is usually formed on termination of the reaction by means of a protic deactivating agent. The halogen atom in this terminal group generally originates from the Lewis acid used for the polymerization. Halogen is preferably chlorine. These telechelic polyisobutenes are valuable intermediates for the preparation of further bifunctional polyisobutene derivatives. Examples of derivative formation are the alkylation of phenols and the elimination of hydrogen halide from the group —CH₂—C(CH₃)₂-halogen to form an ethylenically unsaturated terminal group.

The conversion of the terminal group —CH₂—C(CH₃)₂-halogen into an ethylenically unsaturated radical (methylidene double bond) can be carried out, for example, thermally, e.g. by heating to from 70 to 200° C., or by treatment with a base. Suitable bases are, for example, alkali metal alkoxides such as sodium methoxide, sodium ethoxide and potassium tert-butoxide, basic aluminum oxide, alkali metal hydroxides such as sodium hydroxide and tertiary amines such as pyridine or tributylamine, cf. Kennedy et al., Polymer Bulletin 1985, 13, 435-439. Preference is given to using sodium ethoxide.

However, it is also possible to obtain polyisobutenes which are ethylenically terminated at the end of the chain without introducing a —CH₂—C(CH₃)₂-halogen group beforehand. For this purpose, the living chain end of the isobutene polymer is appropriately reacted with a terminating reagent which attaches an ethylenically unsaturated group to the chain end.

Suitable terminating reagents are, for example, trialkylallylsilane compounds, e.g. trimethylallylsilane. The living chain end is in this case terminated by addition of a trialkylallylsilane compound. The use of the allylsilanes leads to termination of the polymerization with introduction of an allyl group at the end of the polymer chain, cf. EP 264 214.

Another example of a terminating reagent is 1,1-diphenylethylene. The living chain end is in this case terminated by addition of 1,1-diphenylethylene and a base, as a result of which a diphenyl-substituted double bond is introduced at the end of the chain, cf. J. Feldthusen, B. Iván, A. H. E. Müller and J. Kops, Macromol. Rep. 1995, A32, 639, J. Feldthusen, B. Iván and A. H. E. Müller, Macromolecules 1997, 30, 6989, and Macromolecules 1998, 31, 578, DE-A 19648028 and DE-A 19610350.

Furthermore, conjugated dienes, e.g. butadiene, are also suitable as terminating reagents. Here, the reactive chain end is reacted with the conjugated diene and subsequently deactivated as described above, cf. DE-A 40 25 961.

In addition, telechelic polyisobutenes which have an ethylenically unsaturated group derived from the radical A of the compound I at all the chain ends can be obtained by the process of the present invention. For this purpose, two or more living polymer chains are coupled by addition of a coupling agent. In this context, “coupling” means the formation of chemical bonds between the reactive chain ends, so that two or more polymer chains are joined to form one molecule. The molecules obtained by coupling are symmetrical telechelic or star-shaped molecules having ethylenically unsaturated groups A at the ends of the molecule or the ends of the branches of the star-shaped molecule. In this way, coupling of living copolymers of the type AB⁺ can also be used to prepare triblock copolymers of the type AB-BA, where A is a polyisobutene block and B is a different polymer block, e.g. a polyvinylaromatic block.

Suitable coupling agents have, for example, at least two electrofugic leaving groups, e.g. trialkylsilyl groups, located in the allyl position relative to the same double bond or different double bonds, so that the cationic center of a reactive chain end can be added on in a concerted reaction with elimination of the leaving group and relocation of the double bond. Other coupling agents have at least one conjugated system onto which the cationic center of a reactive chain end can add electrophilically to form a stabilized cation. Elimination of a leaving group, e.g. a proton, then results in reformation of the conjugated system and formation of a stable s bond to the polymer chain. A plurality of these conjugated systems can be joined to one another via inert spacers.

Suitable coupling agents include:

(i) compounds which have at least two 5-membered heterocycles containing a heteroatom selected from among oxygen, sulfur and nitrogen, e.g. organic compounds having at least two furan rings, for example

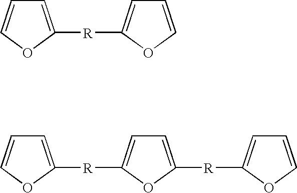

where R is C₁-C₁₀-alkylene, preferably methylene or 2,2-propanediyl;

(ii) compounds having at least two trialkylsilyl groups in allylic positions, for example 1,1-bis(trialkylsilylmethyl)ethylenes, e.g. 1,1-bis(trimethylsilylmethyl)ethylene,

bis[(trialkylsilyl)propenyl]benzenes, e.g.

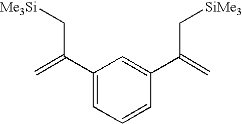

(where Me is methyl),

(iii) compounds having at least two vinylidene groups which are each conjugated with two aromatic rings, for example bisdiphenylethylenes, e.g.

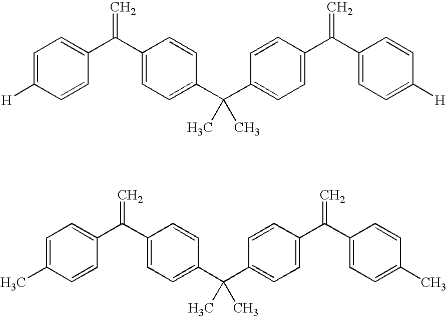

A description of suitable coupling agents may be found in the following references; the coupling reaction can be carried out in a manner analogous to the reactions described there: R. Faust, S. Hadjikyriacou, Macromolecules 2000, 33, 730-733; R. Faust, S. Hadjikyriacou, Macromolecules 1999, 32, 6393-6399; R. Faust, S. Hadjikyriacou, Polym. Bull. 1999, 43, 121-128; R. Faust, Y. Bae, Macromolecules 1997, 30, 198; R. Faust, Y. Bae, Macromolecules 1998, 31, 2480; R. Storey, Maggio, Polymer Preprints 1998, 39, 327-328; WO99/24480; U.S. Pat. No.5,690,861 and U.S. Pat. No.5,981,785.

Coupling is generally carried out in the presence of a Lewis acid. Suitable Lewis acids are those which can also be used for carrying out the actual polymerization reaction. Furthermore, the coupling reaction can be carried out using the same solvents and temperatures which are used to carry out the actual polymerization reaction. The coupling can therefore advantageously be carried out as a single-vessel reaction subsequent to the polymerization reaction in the same solvent and in the presence of the Lewis acid used for the polymerization. It is usual to use a molar amount of coupling agent which corresponds approximately to the molar amount of initiator of the formula I used for the polymerization divided by the number of coupling sites on the coupling agent.

After termination (deactivation and/or introduction of an ethylenically unsaturated terminal group) or coupling, the solvent is generally removed in suitable apparatuses such as rotary evaporators, falling film evaporators or thin film evaporators or by depressurization of the reaction solution.

The isobutene polymers prepared by the process of the present invention have a narrow molecular weight distribution. The polydispersity index PDI=M_{w}/Mₙ is preferably below 1.60, particularly preferably below 1.40 and in particular below 1.35.

The process of the present invention is preferably used for preparing polyisobutenes having a number average molecular weight Mₙ of from 200 to 100000, particularly preferably from 400 to 50000 and in particular from 500 to 15000.

The isobutene polymers prepared according to the present invention are terminated at one end of the chain (start of the chain) by the ethylenically unsaturated group A of the initiator of the formula I. The opposite (distal) end group is preferably a —CH₂—C(CH₃)₂-halogen group, particularly preferably —CH₂—C(CH₃)₂—Cl. As an alternative, the opposite group is preferably an ethylenically unsaturated group which is obtainable as described above either thermally or by reacting the halogen-substituted chain end with a suitable base or by reacting the living polyisobutene chains formed in the polymerization with a trialkylallylsilane compound, with 1,1-diphenylethylene or a conjugated diene. In addition, coupling the living polyisobutene chains in the process of the present invention makes it possible to obtain polyisobutenes which are terminated by the ethylenically unsaturated group A of the initiator of the formula I at all chain ends.

The present invention further provides a polyisobutene which is terminated at at least one end of the molecule by a group of the formula II,

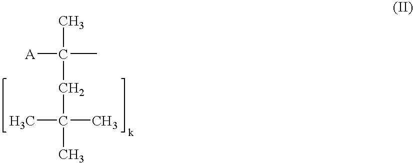

where A and k are as defined above,

or a functionalization product thereof which is obtainable by

i) hydrosilylation,

ii) hydrosulfurization,

iii) electrophilic substitution on aromatics,

iv) epoxidation and, if desired, reaction with nucleophiles,

v) hydroboration and, if desired, oxidative cleavage,

vi) reaction with an enophile in an ene reaction,

vii) addition of halogens or hydrogen halides or

viii) hydroformylation.

A in the radical of the formula II is preferably a group of the formula A.1.1, A.2.1 or A.3.1

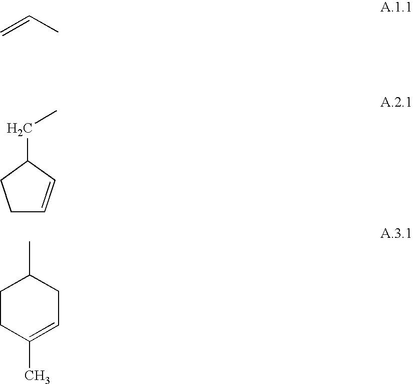

Particular preference is given to A in the radical of the formula II being a group A.1.1 or A.3.1 and in particular A.1.1.

The functionalization reactions described can be carried out not only on the terminating group II but also on an unsaturated group at the opposite end of the chain.

i) Hydrosilylation

To carry out the functionalization, a polyisobutene prepared by the process of the present invention can be subjected to a reaction with a silane in the presence of a silylation catalyst to give a polyisobutene which is at least partially functionalized with silyl groups.

Suitable hydrosilylation catalysts are, for example, transition metal catalysts in which the transition metal is preferably selected from among Pt, Pd, Rh, Ru and Ir. Suitable platinum catalysts include, for example, platinum in finely divided form (“platinum black”), platinum chloride and platinum complexes such as hexachloroplatinic acid or divinyldisiloxane platinum complexes, e.g. tetramethyldivinyldisiloxane-platinum complexes. Examples of suitable rhodium catalysts are RhCl(P(C₆H₅)₃)₃ and RhCl₃. RuCl₃ and IrCl₃ are also suitable. Further suitable catalysts are Lewis acids such as AlCl₃ or TiCl₄ and peroxides. It may be advantageous to use combinations or mixtures of the abovementioned catalysts.

Suitable silanes are, for example, halogenated silanes such as trichlorosilane, methyldichlorosilane, dimethylchlorosilane and trimethylsiloxydichlorosilane; alkoxysilanes such as methyldimethoxysilane, phenyldimethoxysilane, 1,3,3,5,5,7,7-heptamethyl-1,1-dimethoxytetrasiloxane and trialkoxysilanes, e.g. trimethoxysilane and triethoxysilane, and also acyloxysilanes. Preference is given to using trialkoxysilanes.

The reaction temperature in the silylation is preferably in a range from 0 to 140° C., particularly preferably from 40 to 120° C. The reaction is usually carried out under atmospheric pressure, but it can also be carried out under superatmospheric pressures, e.g. in the range from about 1.5 to 20 bar, or reduced pressures, e.g. from 200 to 600 mbar.

The reaction can be carried out in the absence of solvent or in the presence of a suitable solvent. Preferred solvents are, for example, toluene, tetrahydrofuran and chloroform.

ii) Hydrosulfurization

To carry out the functionalization, a polyisobutene prepared by the process of the present invention can be subjected to a reaction with hydrogen sulfide or a thiol, e.g. alkyl or aryl thiols, hydroxymercaptans, aminomercaptans, thiocarboxylic acids or silane thiols to give a polyisobutene which is at least partially functionalized with thio groups. Suitable hydro-alkylthio additions are described in J. March, Advanced Organic Chemistry, 4th edition, John Wiley & Sons, pp. 766-767, which is hereby fully incorporated by reference. The reaction can generally be carried out either in the absence or presence of initiators or in the presence of electromagnetic radiation. The addition of hydrogen sulfide gives polyisobutenes functionalized with thiol groups. The addition of hydrogen sulfide is preferably carried out at below 100° C. and at a pressure of from 1 to 50 bar, particularly preferably about 10 bar. Furthermore, the addition is preferably carried out in the presence of a cation exchange resin such as Amberlyst 15. In the case of the reaction with thiols in the absence of initiators, the Markovnikov addition products onto the double bond are generally obtained. Suitable initiators for the hydro-alkylthio addition are, for example, protic and Lewis acids, e.g. concentrated sulfuric acid or AlCl₃, and acidic cation exchangers such as Amberlyst 15. Suitable initiators also include those which are capable of forming free radicals, e.g. peroxides or azo compounds. The hydro-alkylthio addition in the presence of these initiators generally gives the anti-Markovnikov addition products. The reaction can also be carried out in the presence of electromagnetic radiation having a wavelength of from 400 to 10 nm, preferably from 200 to 300 nm.

iii) Electrophilic Substitution on Aromatics

To form the derivative, a polyisobutene prepared by the process of the present invention can be reacted with a compound which contains at least one aromatic or heteroaromatic group in the presence of an alkylation catalyst. Suitable aromatic and heteroaromatic compounds, catalysts and reaction conditions for this Friedel-Crafts alkylation are described, for example, in J. March, Advanced Organic Chemistry, 4th edition, John Wiley & Sons, pp. 534-539, which is hereby incorporated by reference.

The alkylation is preferably carried out using an activated aromatic compound. Suitable aromatic compounds are, for example, alkylaromatics, alkoxyaromatics, hydroxyaromatics and activated heteroaromatics such as thiophenes or furans.

The aromatic hydroxy compound used for the alkylation is preferably selected from among phenolic compounds which have 1, 2 or 3 OH groups and may bear at least one further substituent. Preferred further substituents are C₁-C₈-alkyl groups, in particular methyl and ethyl. Preferred compounds are, in particular, those of the formula,

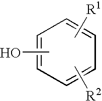

where R¹ and R² are each, independently of one another, hydrogen, OH or CH₃. Particular preference is given to phenol, the cresol isomers, catechol, resorcinol, pyrogallol, fluoroglucinol and the xylenol isomers. In particular, phenol, o-cresol and p-cresol are used. If desired, it is also possible to use mixtures of the abovementioned compounds for the alkylation.

Further suitable compounds are polyaromatics such as polystyrene, polyphenylene oxide or polyphenylene sulfide, or copolymers of aromatics, for example with butadiene, isoprene, (meth)acrylic acid derivatives, ethylene or propylene.

The catalyst is preferably selected from among Lewis-acid alkylation catalysts, which for the purposes of the present invention include both single acceptor atoms and acceptor ligand complexes, molecules, etc., as long as an overall unit displays, i.e. displays toward other molecules, Lewis-acid (electron acceptor) properties. Such catalysts include, for example, AlCl₃, AlBr₃, BF₃, BF₃.2 C₆H₅OH, BF₃[O(C₂H₅)₂]₂, TiCl₄, SnCl₄, AlC₂H₅Cl₂, FeCl₃, SbCl₅ and SbF₅. These alkylation catalysts can be used together with a cocatalyst, for example an ether. Suitable ethers are di(C₁-C₈-alkyl) ethers such as dimethyl ether, diethyl ether, di-n-propyl ether, and also tetrahydrofuran, di(C₅-C₈-cycloalkyl) ethers such as dicyclohexyl ether and ethers having at least one aromatic hydrocarbon radical, e.g. anisole. If a catalyst-cocatalyst complex is used for the Friedel-Crafts alkylation, the molar ratio of catalyst to cocatalyst is preferably in a range from 1:10 to 10:1. The reaction can also be catalyzed by protic acids such as sulfuric acid, phosphoric acid, trifluoromethanesulfonic acid. Organic protic acids can also be in the form of acid groups bound to a polymer, for example as ion exchange resin. Zeolites and inorganic polyacids are also suitable.

The alkylation can be carried out in the absence of solvent or in a solvent. Suitable solvents are, for example, n-alkanes and mixtures thereof and alkylaromatics such as toluene, ethylbenzene and xylene and also halogenated derivatives thereof.

The alkylation is preferably carried out at from −10° C. to +100° C. The reaction is usually carried out at atmospheric pressure, but it can also be carried out under higher or lower pressures.

Appropriate choice of the molar ratios of aromatic or heteroaromatic compound to polyisobutene and choice of the catalyst enables the proportion of alkylated products and their degree of alkylation to be set. Essentially monoalkylated polyisobutenylphenols are generally obtained when using an excess of phenol or in the presence of a Lewis-acid alkylation catalyst when an ether is additionally used as cocatalyst.

Further functionalization can be carried out by subjecting the resulting polyisobutenylphenol to a reaction of the Mannich type with at least one aldehyde, for example formaldehyde, and at least one amine which has at least one primary or secondary amine function to give a compound which is alkylated with polyisobutene and, in addition, at least partially aminoalkylated. It is also possible to use reaction products and/or condensation products of aldehyde and/or amine. The preparation of such compounds is described in WO 01/25 293 and WO 01/25 294, which are hereby fully incorporated by reference.

iv) Epoxidation

To carry out the functionalization, a polyisobutene prepared by the process of the present invention can be reacted with at least one peroxide compound to give an at least partially epoxidized polyisobutene. Suitable epoxidation processes are described in J. March, Advanced Organic Chemistry, 4th edition, John Wiley & Sons, pp. 826-829, which is hereby incorporated by reference. As peroxide compound, use is preferably made of at least one peracid such as m-chloroperbenzoic acid, performic acid, peracetic acid, trifluoroperacetic acid, perbenzoic acid and 3,5-dinitroperbenzoic acid. The peracids can be prepared in situ from the corresponding acids and H₂O₂, if appropriate in the presence of mineral acids. Further suitable epoxidation reagents are, for example, alkaline hydrogen peroxide, molecular oxygen and alkyl peroxides such as tert-butyl hydroperoxide. Suitable solvents for the epoxidation are, for example, customary nonpolar solvents. Particularly useful solvents are hydrocarbons such as toluene, xylene, hexane or heptane. The epoxide formed can subsequently be subjected to a ring-opening reaction with water, acids, alcohols, thiols or primary or secondary amines to give, inter alia, diols, glycol ethers, glycol thioethers and amines.

v) Hydroboration

To carry out the functionalization, a polyisobutene prepared by the process of the invention can be subjected to a reaction with a borane (if desired generated in situ) to give an at least partially hydroxylated polyisobutene. Suitable hydroboration processes are described in J. March, Advanced Organic Chemistry, 4th edition, John Wiley & Sons, pp. 783-789, which is hereby incorporated by reference. Suitable hydroboration reagents are, for example, diborane which is generally generated in situ by reaction of sodium borohydride with BF₃-etherate, diisoamylborane (bis[3-methylbut-2-yl]borane), 1,1,2-trimethylpropylborane, 9-borabicyclo[3.3.1]nonane, diisocamphenylborane, which are obtainable by hydroboration of the corresponding alkenes by means of diborane, chloroborane dimethyl sulfide, alkyldichloroboranes or H₃B—N(C₂H₅)₂.

The hydroboration is usually carried out in a solvent. Suitable solvents for the hydroboration are, for example, acyclic ethers such as diethyl ether, methyl tert-butyl ether, dimethoxyethane, diethylene glycol dimethyl ether, triethylene glycol dimethyl ether, cyclic ethers such as tetrahydrofuran or dioxane and also hydrocarbons such as hexane or toluene or mixtures thereof. The reaction temperature is generally determined by the reactivity of the hydroboration agent and is normally between the melting and boiling points of the reaction mixture, preferably in the range from 0° C. to 60° C.

The hydroboration agent is usually used in an excess over the alkene. The boron atom adds preferentially onto the less substituted and thus less sterically hindered carbon atom.

The alkylboranes formed are usually not isolated but converted directly by subsequent reaction into the desired products. A very important reaction of alkylboranes is the reaction with alkaline hydrogen peroxide to give an alcohol which preferably corresponds formally to the anti-Markovnikov hydration of the alkene. The alkylboranes obtained can also be subjected to a reaction with bromine in the presence of hydroxide ions to give the bromide.

vi) Ene Reaction

To carry out the functionalization, a polyisobutene prepared by the process of the present invention can be reacted in an ene reaction with at least one alkene having an electrophilically substituted double bond (cf., for example, DE-A 4 319 672 or H. Mach and P. Rath in “Lubrication Science II (1999), pp.175-185, which are hereby fully incorporated by reference). In the ene reaction, an alkene having an allylic hydrogen atom, which is designated as ene, is reacted with an electrophilic alkene, known as the enophile, in a pericyclic reaction which comprises formation of a carbon-carbon bond, a double bond shift and a hydrogen transfer. In the present case, the polyisobutene reacts as the ene. Suitable enophiles are compounds which are also used as dienophiles in the Diels-Alder reaction. Preference is given to using maleic anhydride as enophile. This results in polyisobutenes functionalized at least partially with succinic anhydride groups.

The ene reaction can, if appropriate, be carried out in the presence of a Lewis acid as catalyst. Examples of suitable Lewis acids are aluminum chloride and ethylaluminum chloride.

For further functionalization, a polyisobutene functionalized with succinic anhydride groups, for example, can be subjected to a subsequent reaction selected from among:
a) reaction with at least one amine to give a polyisobutene which is at least partially functionalized with succinimide groups and/or succinamide groups,
b) reaction with at least one alcohol to give a polyisobutene which is at least partially functionalized with succinic ester groups, and
c) reaction with at least one thiol to give a polyisobutene which is at least partially functionalized with succinic thio ester groups.
   vii) Addition of Halogen or Hydrogen Halides

To carry out the functionalization, a polyisobutene prepared by the process of the present invention can be subjected to a reaction with a hydrogen halide or a halogen to give a polyisobutene which is at least partially functionalized with halogen groups. Suitable reaction conditions for the hydro-halo addition are described in J. March, Advanced Organic Chemistry, 4th edition, John Wiley & Sons, pp. 758-759, which is hereby incorporated by reference. The addition of hydrogen halide can in principle be carried out using HF, HCl, HBr and HI. The addition of HI, HBr and HF can in general be carried out at room temperature, while elevated temperatures are generally used for the addition of HCl.

The addition of hydrogen halides can in principle be carried out in the absence or in the presence of initiators or of electromagnetic radiation. When the addition is carried out in the absence of initiators, especially of peroxides, the Markovnikov addition products are generally obtained. When peroxides are added, the addition of HBr generally leads to anti-Markovnikov products.

The halogenation of double bonds is described in J. March, Advanced Organic Chemistry, 4th edition, John Wiley & Sons, pp. 812-814, which is hereby incorporated by reference. The addition of Cl, Br and I can be carried out using the free halogens. To obtain compounds halogenated by more than one halogen, the use of interhalogen compounds is known. The addition of fluorine is generally carried out using fluorine-containing compounds such as CoF₃, XeF₂ and mixtures of PbO₂ and SF₄. Bromine generally adds onto double bonds in good yields at room temperature. The addition of chlorine can be carried out using chlorine-containing reagents such as SO₂Cl₂, PCl₅ etc., instead of the free halogen.

If the halogenation is carried out using chlorine or bromine in the presence of electromagnetic radiation, this gives essentially the products of free-radical substitution on the polymer chain and not, or only to a minor extent, products of addition onto the terminal double bond.

Preferred functionalization products are the bisepoxides, dithiols, diols (anti-Markovnikov products as are obtainable from, for example, hydroboration and Markovnikov products as are obtainable from, for example, epoxidation and subsequent reaction of the epoxide with water and, if desired, an acid) and bis(trialkoxysilanes).

Particular polyisobutenes obtainable by the process of the present invention which are terminated by a group of the formula II at one end of the chain and have a terminating group of the type described above, which is different therefrom, at the opposite end of the chain can be differently functionalized owing to the different reactivities of the terminal groups. This is advantageous, in particular, for the use of the polyisobutene in fuels and lubricants, since both hydrophilic and hydrophobic properties are required here. Furthermore, the ready availability of the compound of the formula I is advantageous. Since the compound of the formula I initiates only a chain growing at one end, the required amount of Lewis acid and termination reagent is reduced compared to polyfunctional initiators. In addition, the terminating group originating from the initiator is not subject to the abovementioned secondary reactions which occur when using polyfunctional aromatic initiators of the type used in the prior art.

The following examples illustrate the invention.

### EXAMPLES

1. Preparation of the Initiator 2-chloro-2-methyl-3-butene

300 ml of isoprene and 30 ml of diethyl ether were placed in a 0.5 1 four-neck flask. 110 g of hydrogen chloride were then passed in at −20° C. and the mixture was stirred at −5° C. for 1.5 hours. Nitrogen was subsequently blown in to remove unreacted hydrogen chloride. After extraction of the reaction mixture with 200 ml of water in a separating funnel, the organic phase was separated off, dried over sodium sulfate and filtered. The filtrate was subsequently freed of solvent and unreacted isoprene by distillation at 40° C. and 300 mbar. This gave 281.6 g of a mixture of 70% of 2-chloro-2-methyl-3-butene and 30% of 4-chloro-2-methyl-2-butene from which the title compound was isolated by distillation via a 50 cm distillation column provided with 4 mm wire mesh helices.

Boiling point: 38-45° C. (285 mbar) ¹H-NMR (CDCl₃; 500 MHz): 6.95 (dd, 1H); 5.23 (d,1H); 5.03 (d, 1H); 1.69 (s, 6H).

2. Polymerization of Isobutene

An apparatus comprising a 1 l four-neck flask provided with dropping funnel, dry ice cooler, thermometer, septum and magnetic stirrer (reaction flask) having a direct connection to a 1 l condensation flask provided with a graduated dropping funnel with dry ice cooling was made inert by evacuation and admission of dry nitrogen (twice). 300 ml of dry hexane (dried over 3A molecular sieves at −78° C.), 250 ml of isobutene (condensed at −78° C. and prepurified over aluminum oxide) and 300 ml of methylene chloride were placed in the condensation flask which had been cooled to −20° C. by means of acetone/dry ice. 50-100 mg of phenanthroline were subsequently added and the mixture was titrated with 1.6 M n-butyllithium in hexane until the color changed to reddish brown (about 5 ml). The dry ice bath was replaced by a water bath and the reaction mixture was distilled into the reaction flask which was cooled by means of dry ice. At a temperature of −70° C., 2.38 g (9.9 mmol) of phenyltriethoxysilane, 8.6 g (82.7 mmol) of 2-chloro-2-methyl-3-butene and 8.17 g (43.0 mmol) of titanium tetrachloride were then added in succession via the septum. The reaction mixture was stirred at a temperature of from −55 to −60° C. for 2 hours and subsequently deactivated by addition of 20 ml of ethanol which had been precooled to −50° C. The resulting mixture was washed three times with water, dried over sodium sulfate and filtered. The filtrate was finally freed of the solvents on a rotary evaporator at a final temperature of 180° C. and a final pressure of 3 mbar. This gave 111 g of isobutene polymer having a number average molecular weight Mₙ of 4060 and a polydispersity index PDI of 1.27.

1. A process for preparing a bifunctional polyisobutene comprising polymerizing isobutene or an isobutene-containing monomer mixture in the presence of a Lewis acid and a compound of the formula I 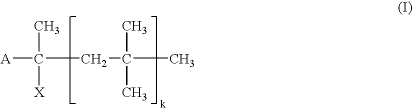
where
X is halogen, C₁-C₆-alkoxy or C₁-C₆-acyloxy,
A is a radical of the formulae A.1, A.2 or A.3 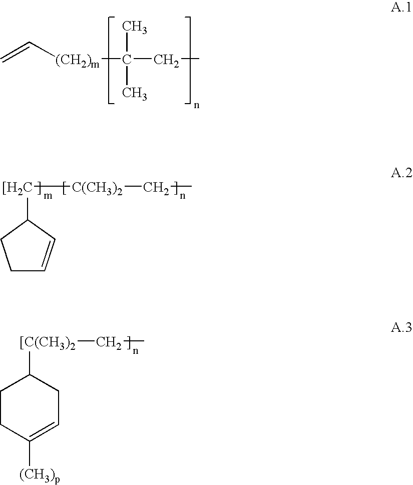
where in A.1
m is 0 and n is 1 or 2; or
m is 1 and n is 0, 1 or 2; and
in A.2 and A.3
m is 0 or 1;
n is from 0 to 3 and
p is 0 or 1, and
k is from 0 to 5.

2. The process as claimed in claim 1, wherein A is a radical of the formulae A.2 or A.3.

3. The process as claimed in claim 1, wherein the compound of the formula I is at least one compound selected from the group consisting of 2-chloro-2-methyl-4-pentene, 2-chloro-2,4,4-trimethyl-5-hexene, 2-chloro-2-methyl-3-(cyclopenten-3-yl)propane, 2-chloro-2-methyl-4-(cyclohexen-4-yl)pentane and 2-chloro-2-(1-methylcyclohexen-4-yl)propane.

4. The process as claimed in claim 1, wherein the Lewis acid is at least one Lewis acid selected from the group consisting of titanium tetrachloride, boron trichloride, tin tetrachloride, aluminum trichloride, dialkylaluminum chlorides, alkylaluminum dichlorides, vanadium pentachloride, iron trichloride and boron trifluoride.

5. The process as claimed in claim 1, wherein the reaction is additionally carried out in the presence of an electron donor.

6. The process as claimed in claim 5, wherein the electron donor is at least one compound selected from the group consisting of pyridines, amides, lactams, ethers, amines, esters, thioethers, sulfoxides, nitrites, phosphines and nonpolymerizable, aprotic organosilicon compounds which bear at least one organic radical bound via oxygen.

7. The process as claimed in claim 1, wherein the polymerization is stopped by addition of a protic compound.

8. The process as claimed in claim 7, wherein the product obtained by stopping the polymerization by means of a protic compound is subsequently treated thermally or with a base.

9. The process as claimed in claim 1, wherein living polyisobutene formed during the polymerization of isobutene or of the isobutene-containing monomer mixture is reacted with at least one comonomer before the polymerization is stopped.

10. The process as claimed in claim 9, wherein the living polyisobutene formed in the polymerization of isobutene or of the isobutene-containing monomer mixture is reacted with a conjugated diene before the polymerization is stopped.

11. The process as claimed in claim 9, wherein the living polyisobutene formed in the polymerization of isobutene or of the isobutene-containing monomer mixture is reacted with a trialkylallylsilane compound or 1,1-diphenylethene together with a base.

12. The process as claimed in claim 9, wherein the living polyisobutene formed in the polymerization of isobutene or of the isobutene-containing monomer mixture is reacted with a coupling agent so that two or more polymer chains are joined together via their distal end.

13. The process as claimed in claim 12, wherein the coupling agent is selected from the group consisting of
i) compounds having at least two 5-membered heterocycles containing a heteroatom selected from among oxygen, sulfur and nitrogen,
ii) compounds having at least two trialkylsilyl groups in allylic positions, and
iii) compounds having at least two vinylidene groups conjugated with two aromatic rings.

14. A polyisobutene which is terminated at at least one end of the molecule by a group of the formula II 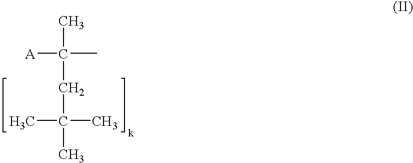
where A is a group of the formula A.3.1 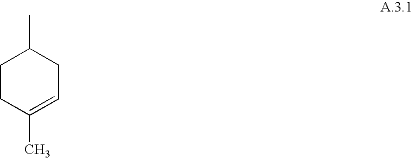
and k is as defined in claim 1,
or a functionalization product thereof which is obtained by
i) hydrosilylation,
ii) hydrosulfurization,
iii) electrophilic substitution on aromatics,
iv) epoxidation and, optionally, reaction with nucleophiles,
v) hydroboration and, optionally, oxidative cleavage,
vi) reaction with an enophile in an ene reaction,
vii) addition of halogens or hydrogen halides or
viii) hydroformylation.
